(19) United States
(12) Patent Application Publication
(10) Pub. No.: US 2010/0233077 A1
(43) Pub. Date: Sep. 16, 2010

(54) Solid Hydrogen Fuel and Method of Manufacturing and Using the Same

(75) Inventors: Jie-Ren Ku, Kaohsiung City (TW); Shing-Fen Tsai, Tainan County (TW); Ya-Yi Hsu, Tainan County (TW); Chan-Li Hsueh, Kaohsiung County (TW); Ming-Shan Jeng, Xizhi City (TW); Fanghei Tsau, Kaohsiung County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: INDUSTRIAL TECHNOLOGY RESEARCH INSTITUTE, Hsinchu (TW)

(21) Appl. No.: 12/472,582

(22) Filed: May 27, 2009

(30) Foreign Application Priority Data
Mar. 13, 2009 (TW) 98108327

(51) Int. Cl. C01B 3/04; C10L 5/00

(52) U.S. Cl. 423/658.2; 44/504; 44/503

(57) ABSTRACT

A solid hydrogen fuel is formed into a solid pressure-formed block. The method of manufacturing the solid hydrogen fuel includes following steps. First, at least a hydride powder and at least a hydrogen releasing catalyst powder are mixed well. Next, the mixed powder is bonded into a block by pressure. When in use, the solid hydrogen fuel is mixed with water to produce hydrogen. The hydride powder and water bring about a hydrogen releasing reaction. The hydride releasing catalyst powder is used for catalyzing the hydrogen releasing reaction to produce hydrogen. The solid hydride has higher hydrogen production and can release hydrogen completely.

This application claims the benefit of Taiwan application Serial No. 98108327, filed Mar. 13, 2009, the subject matter of which is incorporated herein by reference.

### BACKGROUND OF THE INVENTION

1. Field of the Invention

The invention relates in general to a solid hydrogen fuel and method of manufacturing and using the same, and more particularly to a solid hydrogen fuel which can be used easily and capable of releasing hydrogen effectively. The method of using the solid hydrogen fuel of the invention is a great breakthrough in the liquid hydrogen fuel.

2. Description of the Related Art

Fuel cell is a device capable of converting chemical energy into electrical energy. The fuel cell can generate electrical energy continuously while fuel and oxidant are provided constantly. As to the hydrogen fuel cell, the fuel is hydrogen, and the oxidant is oxygen. However, hydrogen is dangerous and flammable gas, and the storage condition is strict. Therefore, hydride solution or hydrogen storage material containing hydrogen is used as hydrogen source conventionally. Hydrogen is abstracted there-from to be provided for the fuel cell.

A conventional hydrogen production system in a hydrogen fuel cell and an operating method thereof are described as follows. Sodium borohydride solution is used as hydrogen source in the hydrogen production system. Please refer to FIG. 1. FIG. 1 illustrates a conventional hydrogen production system. The conventional hydrogen production system 110 is used for abstracting hydrogen from sodium borohydride solution to provide hydrogen for a fuel cell 100. The hydrogen production system 110 includes a fuel tank 111, a recycle tank 112, a pump 113, a catalyst bed 114, a gas liquid separation chamber 115, a pressure sensor 116 and a controller 117.

In FIG. 1, the controller 117 is coupled with the controller 117 and the pressure sensor 116. The pump 113 transports sodium borohydride solution (liquid fuel) to the catalyst bed 114. After hydrogen is released, sodium perborate solution is extracted from the catalyst bed 114. The chemical equation (1) is as follows:

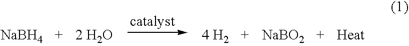

When the conventional hydrogen production system 110 starts to operate, the controller 117 controls the pump 113 according to the pressure of hydrogen detected in the gas liquid separation chamber 115 by the pressure sensor 116, for further controlling the hydrogen production. When the pressure sensor 116 detects that the pressure of hydrogen is insufficient, the pump 113 transports sodium borohydride solution in the fuel tank 111 and the produced water of the fuel cell 100 to the catalyst bed 114. The hydrolysis reaction of sodium borohydride is accelerated by the catalytic action of the catalyst bed 114 to produce hydrogen rapidly. Then, in the gas liquid separation chamber 115, the product of the hydrolysis reaction of sodium borohydride, namely sodium perborate solution, is transported back to the recycle tank 112 to be stored. Hydrogen is transported to the anode of the fuel cell 100 to bring about an electrochemical reaction for continuously producing direct current and produced water. However, as the equation (1) shows, the precipitation of sodium borohydride/sodium perborate clogs the pipes. As a result, the pump 113 cannot pump the liquid fuel into the catalyst bed 114, which stops the production of hydrogen.

Moreover, liquid sodium borohydride solution is used as the hydrogen source conventionally and hydrogen is extracted there-from. Therefore, the production of hydrogen is limited by the solubility of sodium borohydride in water. For example, in the hydrolysis reaction of solid sodium borohydride, the theoretical production of hydrogen can reach 10.8 wt %. However, when sodium borohydride is used in the form of solution, the solubility of sodium borohydride must be considered. The solubility of sodium borohydride in water is about 0.55 g NaBH₄/1 g H₂O at room temperature, which results in the theoretical production of hydrogen to be 7.5 wt %. Furthermore, in order to avoid the precipitation of sodium perborate to clog the pipe, the solubility of sodium perborate in water has to be considered. The solubility of sodium perborate in water is about 0.28 g NaBO₂/1 g H₂O. Therefore, practically the theoretical production of hydrogen is only 4.6 wt %.

Besides, the conventional liquid hydrogen fuel has the problem that hydrogen cannot be released in a short time. FIG. 2A illustrates a method of use of conventional liquid hydrogen fuel. FIG. 2B shows the curve of hydrogen release using conventional liquid hydrogen fuel. When conventional liquid hydrogen fuel is in use, catalyst 14 can be added to alkaline liquid sodium borohydride (NaBH₄) solution 11. Hydrogen is released when the catalyst 14 contacts and reacts with the solution 11. 1 g sodium borohydride is dissolved in 40 g water to form sodium hydride solution. 0.2 g cation exchange resin (IR-120) chelating cobalt ions (Co²⁺/IR-120) is used as catalyst. The hydrogen release curve in FIG. 2B is obtained by the method of use of conventional liquid hydrogen fuel shown in FIG. 2A.

However, in addition to the solubility of sodium perborate in water, there are still other problems. As shown in FIG. 2B, right after hydrogen is released in the beginning, the hydrogen-releasing rate decreases rapidly. After dropping down to point A, the hydrogen-releasing rate remains low for a long time. At the end of the time axis, the hydrogen-releasing rate still stays low. Therefore, conventional liquid hydrogen fuel can not completely release hydrogen in a short time.

As stated above, when liquid fuel is in use, the problem of solubility lowers the theoretical production of hydrogen from 10.8 wt % to 4.6 wt %, which results in great loss in hydrogen storage amount. Even when larger fuel tank and recycle tank are used for making up the loss, the great volume limits the application of the fuel cell. Furthermore, the liquid hydrogen source such as sodium borohydride solution makes the system mechanism design more complicated, which also limits the application of the product. Moreover, as to the conventional method using the contact reaction of catalyst and borohydride solution to release hydrogen, hydrogen cannot be released completely in a short time.

### SUMMARY OF THE INVENTION

The invention relates to a solid hydrogen fuel and a manufacturing method and a method of use thereof. Solid hydride powder and solid catalyst powder are mixed well and then bonded by pressure to form a solid hydrogen fuel. Hydrogen can be produced by simply mixing the solid hydrogen fuel with water, and the hydrogen-releasing rate is high. Therefore, the solid hydrogen fuel can be applied to high power fuel cell. After formed into a block by pressure, the solid hydrogen fuel is easy to carry with and can be shaped into various forms. It is easier to fit the solid hydrogen fuel into the mechanism design of the system and product, which further increases the users' willingness to use the product. Besides, compared to the conventional method using hydride solution to produce hydrogen, the hydrogen production of solid hydride is higher, and hydrogen can be released completely in a short time.

According to the present invention, a method of manufacturing solid hydrogen fuel is provided. First, solid hydride powder and solid catalyst powder are mixed well. Mixed powder is formed into a block by pressure. The block includes at least a hydride powder and at least a hydrogen releasing catalyst powder which are mixed well. According to the present invention, a solid hydrogen fuel is provided. The solid hydrogen fuel includes at least a hydride powder and at least a hydrogen releasing catalyst powder which are mixed well. The hydride powder and the hydrogen releasing catalyst powder are bonded by pressure to form a block.

According to the present invention, a method of use of solid hydrogen fuel is provided. The solid hydrogen fuel includes at least a hydride powder and at least a hydrogen releasing catalyst powder which are mixed well. Hydrogen can be released by just adding water to the above-described solid hydrogen fuel. The hydride powder in the solid hydrogen fuel reacts with water to release hydrogen. The hydrogen releasing catalyst powder is for catalyzing the reaction to produce hydrogen.

The invention will become apparent from the following detailed description of the preferred but non-limiting embodiments. The following description is made with reference to the accompanying drawings.

### BRIEF DESCRIPTION OF THE DRAWINGS

FIG. 1 illustrates a conventional hydrogen production system;

FIG. 2A illustrates a method of use of conventional liquid hydrogen fuel;

FIG. 2B shows the curve of hydrogen release using conventional liquid hydrogen fuel;

FIG. 3 illustrates the hydrogen production system using the solid hydrogen fuel of the present invention;

FIG. 4A illustrates the method of use of the solid hydrogen fuel of the embodiment of the present invention;

FIG. 4B shows the curve of hydrogen release using the solid hydrogen fuel of the embodiment of the present invention; and

FIG. 5 shows hydrogen production rate (conversion rate) of two solid hydrogen fuel of the embodiment of the present invention.

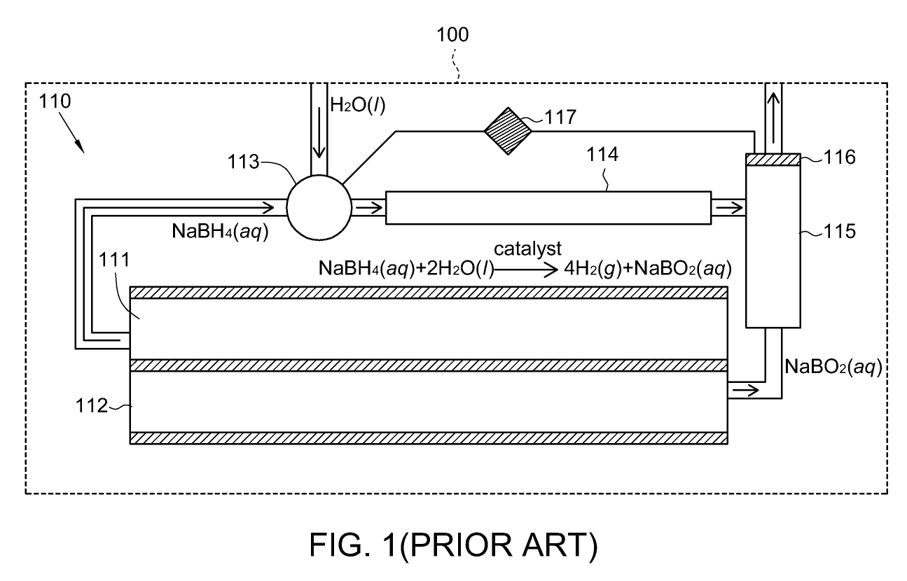

Table 1 is a diagram that shows the weight percentage of hydrogen production of two solid hydrogen fuels of the embodiment of the present invention.

### DETAILED DESCRIPTION OF THE INVENTION

### Solid Hydrogen Fuel

In an embodiment of the present invention, a solid hydrogen fuel used in a fuel cell to produce hydrogen is provided. Solid hydride powder and catalyst powder are mixed well to form the solid hydrogen fuel. The solid hydrogen fuel and water are mixed to produce hydrogen as the chemical equation (1) shows. The hydrogen-releasing rate is high. Therefore, the solid hydrogen fuel can be applied to high power fuel cell. Moreover, compared to conventional hydride solution, the hydrogen production of solid hydride is greater than that of conventional liquid hydride (the theoretical production of conventional liquid hydride can only reach 4.6 wt %). Furthermore, after powder is formed into a block by pressure, the block is easy to carry and can be shaped into various forms. It is easier to fit the block into the mechanism design of the system and product, which further increases users' willingness to use the product.

According to the embodiment of the present invention, the solid hydrogen fuel includes first hydride powder and hydrogen releasing catalyst powder. The first hydride powder is for reacting with water to release hydrogen. The hydrogen releasing catalyst powder is mixed well with the first hydride powder and used for catalyzing the hydrogen releasing reaction, in order to increase the production of the hydrogen.

Various structures of hydrogen catalyst powder can be used in the solid hydrogen fuel of the present embodiment. Three types of hydrogen catalyst powder are described as follows to illustrate the hydrogen releasing catalyst powder of the solid hydrogen fuel of the present embodiment. However, the present invention is not limited thereto. The first catalyst powder is for example metal nano-particles (namely, the first catalyst powder includes plenty of metal nano-particles). The second catalyst powder is for example catalyst carriers with plenty of metal atoms and/or metal nano-particles (namely, the second catalyst powder includes plenty of catalyst carriers and metal atoms and/or metal nano-particles, and the metal atoms and/or metal nano-particles covers the surface of the catalyst carriers). The third catalyst powder is for example catalyst carriers chelating plenty of metal ions on the surface (namely, the third catalyst powder includes plenty of catalyst carriers and metal ions, and the catalyst carriers chelate metal nano-particles on the surface).

Preferably, but non-restrictively, the above-described metal nano-particles includes at least one or more selected from the group consisting of ruthenium, cobalt, nickel, iron, manganese and copper. For example, the first catalyst powder includes two or more metal nano-particles. For another example, the catalyst carriers of the second catalyst powder can include two or more metal nano-particles. Similarly, the above-described metal ions include at least one or more selected from the group consisting of ruthenium, cobalt, nickel, iron, manganese and copper. For example, the third catalyst powder can include two or more metal ions.

Furthermore, in the composition of solid hydrogen fuel, the weight percentage of catalyst powder to the total weight is preferably between 0.0001 wt % and 50 wt %. The average particle size of the second catalyst powder and the third catalyst powder is preferably between 1 μm and 10 mm. The range is different depending on the metal or metal ions in use. Take ruthenium for example. The cost of ruthenium is higher, but it has a great catalytic effect on hydrolysis reaction of sodium borohydride. Therefore, the weight percentage of ruthenium can be lowered when the application demand is met, for reducing the manufacturing cost. Therefore, the type of metal and the weight percentage of the catalyst powder can be adjusted according to the practical conditions. The present invention is not limited thereto.

In the composition of solid hydrogen fuel of the present invention, solid sodium borohydride is used as the first hydride of the present invention as an example. The rate of hydrolysis reaction of sodium borohydride is good, and sodium borohydride is inexpensive and easy to be obtained. Sodium borohydride is stable in the dry condition under room temperature. It is easy to grind sodium borohydride for forming powder. However, when applied practically, the present invention is not limited thereto.

Furthermore, the second hydride powder can be added into the composition of solid hydrogen fuel. The second hydride powder is mixed well with the first hydride powder and the hydrogen releasing catalyst powder. Also, the second hydride powder acts with water to bring about a second hydrogen releasing reaction. Meanwhile, hydrogen releasing catalyst powder catalyzes the second hydrogen releasing reaction to accelerate the production of hydrogen.

The second hydride powder is preferably a hydride with greater rate of hydrolysis reaction than sodium borohydride, for increasing the total production of hydrogen. For example, the second hydride powder can be selected from the group consisting of lithium aluminum hydride, sodium aluminum hydride, magnesium aluminum hydride, calcium aluminum hydride, lithium borohydride, potassium borohydride, beryllium borohydride, magnesium borohydride, calcium borohydride, lithium hydride, sodium hydride, magnesium hydride and calcium hydride. In an embodiment, the weight percentage of the second hydride to the total weight in the composition of solid hydrogen fuel is preferably between 0.001 wt % and 50 wt %. The ratio (weight percentage) of the second hydride powder is adjusted according to the conditions of the fuel cell which the solid hydrogen fuel is applied to. For example, when the solid hydrogen fuel is applied to a high power fuel cell, the weight percentage of the second hydride powder can be increased to enhance the production of hydrogen for meeting the demand of the high power fuel cell.

### Method of Manufacturing Solid Hydrogen Fuel

In the embodiment of the present invention, a method of manufacturing solid hydrogen fuel is provided. However, the present invention is not limited thereto. Any one who has ordinary skill in the present invention can understand that the method can be modified according to the practical application conditions. The method of manufacturing solid hydrogen fuel includes following steps. First, the first hydride powder and the hydrogen releasing catalyst powder are provided. Please refer to the above description for the composition and percentage of the first hydride powder and the hydrogen releasing catalyst powder.

Next, the first hydride powder and the hydrogen releasing catalyst powder are mixed well. In this step, the first hydride powder and the hydrogen releasing catalyst powder are preferably mixed well by grinding. Or, the hydrogen releasing catalyst powder and the hydride powder are ground respectively, and then the first hydride powder and the hydrogen releasing catalyst powder are mixed well.

Then, it can be decided whether or not to bond the mixed powder by pressure according to the practical conditions. For example, the mixture of the first hydride powder and the hydrogen releasing catalyst powder can be formed into stick-shape or any other shape by pressure. After formed into blocks by pressure, the mixed powder is easy to carry with and the shape can be changed to match the design of the applied system and product.

When the second hydride powder is added into the composition of the solid hydrogen fuel, the above manufacturing method only needs little modification. For example, the step of providing the powder further includes providing the second hydride powder. Similarly, please refer to the above description for the composition and the percentage of the second hydride powder. The step of mixing powder further includes mixing the first hydride powder, the second hydride powder and the hydrogen releasing catalyst powder. The step of forming the powder by pressure further includes forming the mixture of the first hydride powder, the second hydride powder and the hydrogen releasing catalyst powder into a stick shape or any other shape by pressure.

### Method of Producing Hydrogen in a Fuel Cell

In the embodiment of present invention, a method of producing hydrogen in a fuel cell is provided. The method includes following steps. First, solid hydrogen fuel is provided for the fuel cell. The solid hydrogen fuel includes at least the first hydride powder and the hydrogen releasing catalyst powder which are mixed well. The mixed powder is bonded by pressure selectively.

Next, the solid hydrogen fuel is mixed with water to produce hydrogen for the electrode of the fuel cell to use. When the solid hydrogen fuel is mixed with water, the first hydride powder acts with water to release hydrogen. The hydrogen releasing catalyst powder is used for catalyzing the hydrogen releasing reaction to accelerate the production of hydrogen.

Similarly, when the second hydride powder is added into the composition of solid hydrogen fuel, the second hydride powder acts with water to release hydrogen, and the hydrogen releasing catalyst powder catalyzes the hydrogen releasing reaction to accelerate the production of hydrogen in the step of mixing the solid hydrogen fuel and water.

Furthermore, although the catalyst for catalyzing the hydrogen releasing reaction in the fuel cell is costly, it can be recycled to be reused. Therefore, the method of producing hydrogen in the fuel cell according to the present invention can further include a step of recycling the hydrogen releasing catalyst powder. As a result, the limited resource on earth can be saved, and the manufacturing cost is reduced as well.

In the present embodiment, the catalyst for catalyzing the hydrolysis reaction is mixed in the solid hydrogen fuel. Therefore, after the solid hydrogen fuel acts with water completely, the catalyst powder is deposited in sodium perborate solution. Two methods of recycling the hydrogen releasing catalyst powder are described as follows according to the type of the catalyst powder. The first recycling method is applied to the second and the third catalyst powder (the catalyst powder including catalyst carriers). Because the second catalyst powder and the third catalyst powder include catalyst carriers, the average particle size is greater. Therefore, the catalyst powder can be captured and recycled by screening. The second recycling method is applied to the first catalyst powder (the catalyst powder without catalyst carriers). The first catalyst powder is nano-particles. It is difficult to recycle the catalyst powder by screening. Therefore, the magnetic catalyst powder can be collected and recycled by magnet.

A hydrogen production system using the solid hydrogen fuel of the present invention in a fuel cell is described as follows. However, any one who has ordinary skill in the present invention can understand that the practical mechanism design of the fuel cell can be modified even when using the same principle. Appropriate modification can be made according to the practical conditions. Therefore, the fuel cell and the hydrogen production system described later are only used as reference for any one with the ordinary skill in the present invention and not to limit the scope of the invention.

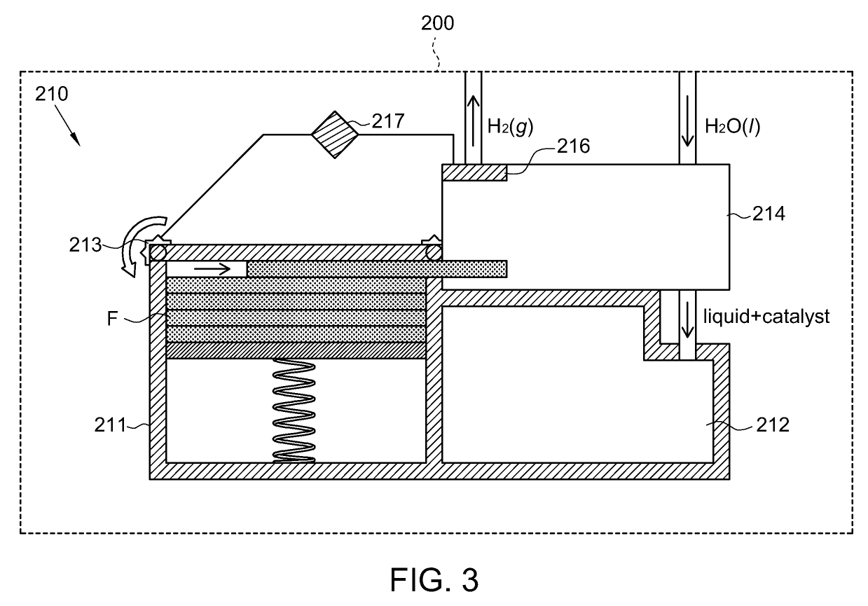

Please refer to FIG. 3. FIG. 3 illustrates the hydrogen production system using the solid hydrogen fuel of the present invention. The hydrogen production system 210 is for mixing the solid hydrogen fuel F and the produced water of the fuel cell 200 to produce hydrogen for the fuel cell 200. The hydrogen production system 210 includes the fuel tank 211, the recycle tank 212, the transmission belt 213, the reaction chamber 214, the pressure sensor 216 and the controller 217.

In FIG. 3, the controller 217 is coupled with the pressure sensor 216 and the transmission belt 213. When the hydrogen production system 210 starts to operate, the controller 217 controls the operation of the transmission belt 213 according to the hydrogen pressure detected in the reaction chamber 214 by the pressure sensor 216, for further controlling the production of hydrogen. When the pressure sensor 216 detects that the hydrogen pressure is insufficient, the transmission belt 213 transports the solid hydrogen fuel F in the fuel tank 211 to the reaction chamber 214 so that the solid hydrogen fuel F reacts with the produced water of the fuel cell 200 to bring about hydrolysis reaction. As a result, hydrogen is produced rapidly. Thereon, the produced solution of the hydrolysis reaction and the deposited catalyst powder are transported to the recycle tank 212 to be stored. Hydrogen is transported to the anode of the fuel cell 200 to bring about an electrochemical reaction for continuously generating direct current and produced water.

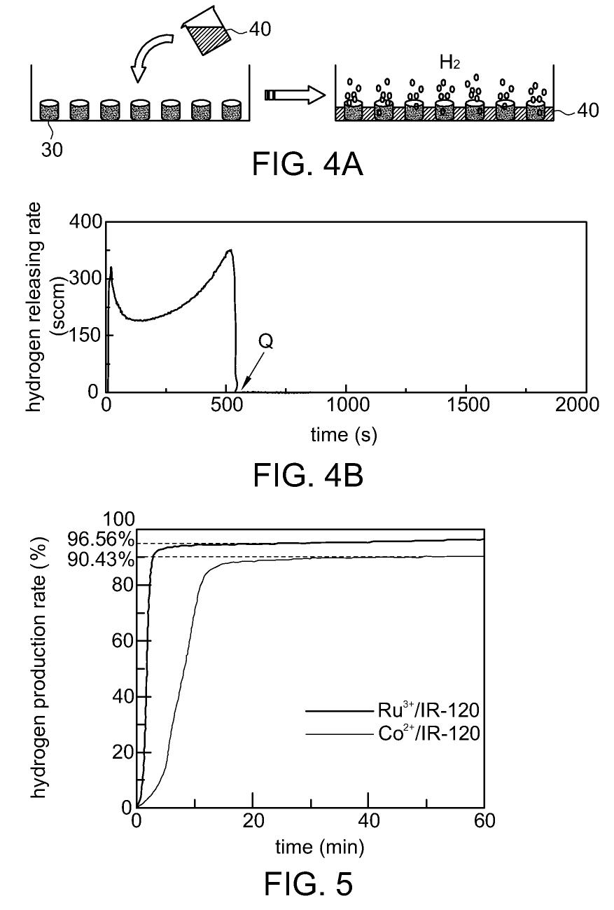

Furthermore, in the method of use of the solid hydrogen fuel (namely, the solid pressure-formed blocks including hydride powder and catalyst powder mixed together), the only step to release hydrogen is to add water. The solid hydrogen fuel works with the fuel cell to generate electricity. It is easy to carry the solid hydrogen fuel (especially when formed into strip shape, stick shape or any other pressure-formed block which is easy to carry with), which significantly increases users' willingness to use the product. Moreover, the shape of the solid hydrogen fuel can be modified to match the mechanism design of the system and product, and therefore the application field is wider. Besides, the solid hydrogen fuel of the present invention can effectively release hydrogen completely. Please refer to FIG. 4A and FIG. 4B. FIG. 4A illustrates the method of use of the solid hydrogen fuel of the embodiment of the present invention. FIG. 4B shows the curve of hydrogen release using the solid hydrogen fuel of the embodiment of the present invention. When the solid hydrogen fuel of the embodiment of the present invention is in use, 40 g water is added to 30 g solid hydrogen fuel to bring about the hydrogen releasing reaction to produce hydrogen. In FIG. 4B, solid pressure-formed blocks including 1 g sodium borohydride powder and 0.2 g cobalt ion catalyst which are mixed together is used as the solid hydrogen fuel 30. The hydrogen releasing curve in FIG. 4B is obtained by adding water (40 g) into the solid hydrogen fuel as shown in FIG. 4A.

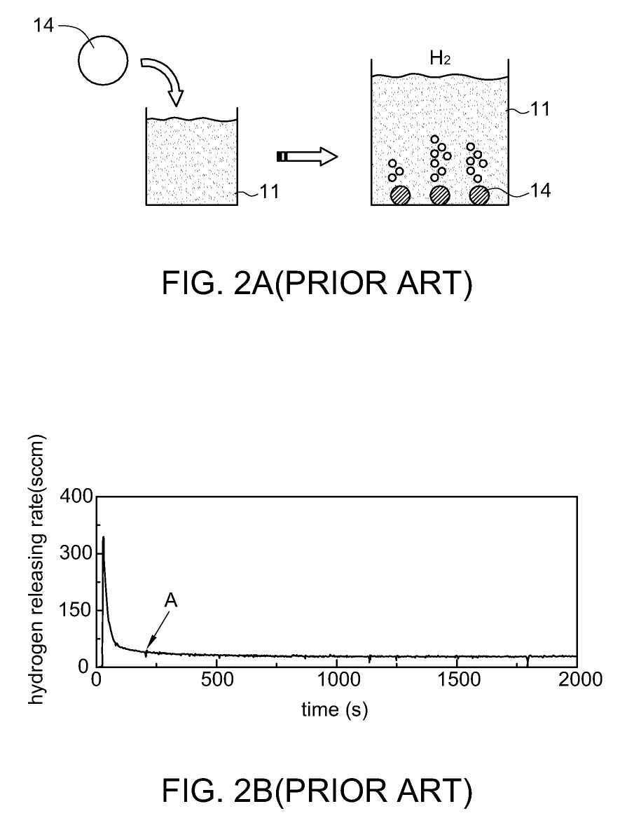

As shown in FIG. 4B, when the solid hydrogen fuel of the embodiment of the present invention is in use, the hydrogen-releasing rate is high in the beginning. Hydrogen is released completely in a short time (about 600 seconds) as the point Q shows (the hydrogen-releasing rate is equal to 0). The hydrogen releasing-rate of the solid hydrogen fuel remains high during the time of releasing hydrogen, which is around 180 sccm to 350 sccm. Compared to FIG. 2B and FIG. 4B, it shows that the solid hydrogen fuel of the embodiment of the present invention releases hydrogen completely in a certain period of time (FIG. 4B). The problem that the hydrogen-releasing rate of the conventional liquid hydrogen fuel remains low for a long time (FIG. 2B) is solved.

Furthermore, compared to conventional hydride solution, the hydrogen production of the solid hydrogen fuel of the embodiment of the present invention is higher (the hydrogen production of conventional liquid hydride can only reach the theoretical production, namely 4.6 wt %). Please refer to FIG. 5 and table 1. FIG. 5 shows hydrogen production rate (conversion rate) of two solid hydrogen fuels of the embodiment of the present invention. Table 1 shows the weight percentage of hydrogen production of two solid hydrogen fuels of the embodiment of the present invention. The hydrogen production in table 1 is calculated by using the hydrogen production rate in FIG. 5. In FIG. 5, about 1 g sodium borohydride and 0.15 g cobalt ion catalyst (Co²⁺/IR-120) or 0.15 g ruthenium ion catalyst (Ru³⁺/IR-120) are mixed together to form the solid pressure-formed blocks to be used as the solid hydrogen fuel 30. The hydrogen production rate in FIG. 5 is obtained by adding water (2 g) into the solid hydrogen fuel, as shown in FIG. 4. The hydrogen production rate in table 1 is calculated based on the hydrogen production rate in FIG. 5.

As shown in FIG. 5, when the solid hydrogen fuel of the embodiment of the present invention is in use, the hydrogen production rate (conversion rate) can be more than 90% of the theoretical value. The hydrogen production rate of cobalt ion catalyst (Co²⁺/IR-120) can reach 90% at about 20 minutes. The hydrogen production rate of ruthenium ion catalyst (Ru³⁺/IR-120) can reach 96% at about 10 minutes. After calculation, the weight percentage of hydrogen production when using (1) cobalt ion catalyst (Co²⁺/IR-120) can reach 6.73%. The weight percentage of hydrogen production when using (2) ruthenium ion catalyst (Ru³⁺/IR-120) can reach 7.35%. The calculation is as follows.
(1) cobalt ion catalyst (Co²⁺/IR-120)

$$The theoretical hydrogen production of 1.09 g sodium borohydride = \frac{1.09}{37.8} \times 4 \times 24.5 = 2.82 ( l )$$

The conversion rate (hydrogen release depth):

$$\frac{2.55}{2.82} \times 100 \% = 90.43 \%$$

$$The weight percentage of hydrogen production = \\ [ \frac{( weight of produced hydrogen )}{( weight of chemical hydride and water )} ] = \frac{( \frac{2.55}{24.5} ) \times 2}{[ ( 1.09 + 2 ) ]} \times 100 \% = 6.73 \%$$

(2) ruthenium ion catalyst (Ru³⁺/IR-120)

$$The theoretical hydrogen production of 1.12 g sodium borohydride = \frac{1.12}{37.8} \times 4 \times 24.5 = 2.91 ( l )$$

The conversion rate (hydrogen release depth):

$$\frac{2.81}{2.91} \times 100 \% = 96.56 \%$$

$$The weight percentage of hydrogen production = \\ [ \frac{( weight of produced hydrogen )}{( weight of chemical hydride and water )} ] = \frac{( \frac{2.81}{24.5} ) \times 2}{[ ( 1.12 + 2 ) ]} \times 100 \% = 7.35 \%$$

The solid hydrogen fuel of the embodiment of the present invention can produce hydrogen by just adding water into it. The method of use is simple, and the hydrogen production rate is high. The solid hydrogen fuel can be applied to high power fuel cell. Furthermore, the greatest hydrogen production of conventional liquid hydride can only reach the theoretical value, namely 4.6 wt %. Compared to conventional liquid hydride, the hydrogen production of the solid hydride of the embodiment is higher, which is about 6.73%˜7.35% wt % (table 1). In other words, compared to hydride solution with the same volume, solid hydrogen fuel carries more hydrogen. Therefore, the required space is reduced effectively, and the weight of the product is lowered. Moreover, after formed into blocks by pressure, powder is easy to carry with and can be shaped into many forms. Electricity can be generated in the hydrogen releasing reaction by just adding water. It is easier to match the mechanism design of the system and product, which simplifies the design of hydrogen production system. Furthermore, solid hydrogen fuel releases hydrogen completely, more effectively and rapidly. Above advantages increase users' willingness to use the product and widen the application field of the product.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

TABLE 1

| | | | | theoretical | | | weight |
|---|---|---|---|---|---|---|---|
| | | | | value of | practical | | percentage of |
| | | | | hydrogen | hydrogen | conversion | hydrogen |
| Reactants | | | catalyst | production | production | rate | production |
| NaBH₄ (g) | H₂O (g) | NaBH₄ (wt %) | (g) | (volume, 1) | (volume, 1) | (%) | (wt %) |
| 1.09 | 2.00 | 35.28 | 0.15^{a} | 2.82 | 2.55 | 90.43 | 6.73 |
| 1.12 | 2.00 | 35.90 | 0.15^{b} | 2.91 | 2.81 | 96.56 | 7.35 |

^{a}cobalt ion catalyst (Co²⁺/IR-120)
^{b}ruthenium ion catalyst (Ru³⁺/IR-120)

What is claimed is:

1. A solid hydrogen fuel, comprising:
at least a hydride powder being able to react with water to bring about a hydrogen releasing reaction for producing hydrogen; and
at least a hydrogen releasing catalyst powder mixed well with the hydride powder to catalyze the hydrogen releasing reaction.

2. The solid hydrogen fuel according to claim 1, wherein the hydride powder and the hydrogen releasing catalyst powder are formed into a solid block by pressure.

3. The solid hydrogen fuel according to claim 1, wherein the hydride powder is sodium borohydride (NaBH₄).

4. The solid hydrogen fuel according to claim 1 comprising a first hydride powder, a second hydride powder and at least the hydrogen releasing catalyst powder, wherein the second hydride powder is mixed well with the first hydride powder and the hydrogen releasing powder, and the first and the second hydride powder respectively react with water to bring about a first and a second hydrogen releasing reactions to produce hydrogen.

5. The solid hydrogen fuel according to claim 4, wherein the percentage of the second hydride powder to the total weight of the solid hydrogen fuel is between 0.001 wt % and 50 wt %.

6. The solid hydrogen fuel according to claim 4, wherein the first hydride powder is sodium borohydride, the second hydride powder is selected from the group consisting of lithium aluminum hydride, sodium aluminum hydride, magnesium aluminum hydride, calcium aluminum hydride, lithium borohydride, potassium borohydride, beryllium borohydride, magnesium borohydride, calcium borohydride, lithium hydride, sodium hydride, magnesium hydride and calcium hydride.

7. The solid hydrogen fuel according to claim 1, wherein the percentage of the hydrogen releasing catalyst powder to the total weight of the solid hydrogen fuel is between 0.001 wt % and 50 wt %.

8. The solid hydrogen fuel according to claim 1, wherein the hydrogen releasing catalyst powder is a plurality of metal nano-particles comprising at least one or more selected from the group consisting of ruthenium, cobalt, nickel, iron, manganese and copper.

9. The solid hydrogen fuel according to claim 1, wherein the hydrogen releasing catalyst powder comprise a plurality of catalyst carriers and metal nano-particles, the metal nano-particles cover the surface of the catalyst carriers, and the metal nano-particles comprises at least one or more selected from the group consisting of ruthenium, cobalt, nickel, iron, manganese and copper.

10. The solid hydrogen fuel according to claim 9, wherein the average particle size of the hydrogen releasing powder is about 1 μm to 10 mm.

11. The solid hydrogen fuel according to claim 1, wherein the hydrogen releasing catalyst powder comprises a plurality of catalyst carriers and metal ions, the metal ions chelate the surface of the catalyst carriers, and the metal ions comprise at least one or more selected from the group consisting of ruthenium, cobalt, nickel, iron, manganese and copper.

12. The solid hydrogen fuel according to claim 11, wherein the average particle size of the hydrogen releasing powder is about 1 μm to 10 mm.

13. A method of manufacturing a solid hydrogen fuel, comprising:
providing at least a solid hydride powder and at least a solid hydrogen releasing catalyst powder, wherein the solid hydride powder reacts with water to bring about a hydrogen releasing reaction to produce hydrogen, and the solid hydrogen releasing catalyst powder catalyzes the hydrogen releasing reaction; and
well mixing the solid hydride powder and the solid hydrogen releasing catalyst powder.

14. The method according to claim 13 further comprising step of forming the well-mixed solid hydride powder and the solid hydrogen releasing powder into a solid block by pressure.

15. The method according to claim 13, wherein the solid hydride powder is sodium borohydride.

16. The method according to claim 15, further comprising:
providing a first solid hydride powder, a second solid hydride powder and at least the solid hydrogen releasing catalyst powder; and
well mixing the first and the second solid hydride powder and at least the solid hydrogen releasing catalyst powder.

17. The method according to claim 16 further comprising step of forming the well-mixed first and second solid hydride powder and the solid hydrogen releasing catalyst powder into a solid block by pressure.

18. The method according to claim 16, wherein the percentage of the second solid hydride powder to the total weight of the second solid hydride powder is between 0.001 wt % and 50 wt %.

19. The method according to claim 16, wherein the first solid hydride powder is sodium borohydride, and the second hydride powder is selected from the group consisting of lithium aluminum hydride, sodium aluminum hydride, magnesium aluminum hydride, calcium aluminum hydride, lithium borohydride, potassium borohydride, beryllium borohydride, magnesium borohydride, calcium borohydride, lithium hydride, sodium hydride, magnesium hydride and calcium hydride.

20. The method according to claim 13, wherein the percentage of the solid hydrogen releasing powder to the total weight is between 0.0001 wt % and 50 wt %.

21. The method according to claim 13, wherein the solid hydrogen releasing catalyst powder is a plurality of solid metal nano-particles comprising one or more selected from the group consisting of ruthenium, cobalt, nickel, iron, manganese and copper.

22. The method according to claim 13, wherein the solid hydrogen releasing catalyst powder comprises a plurality of catalyst carriers and metal nano-particles covering the surface of the catalyst carries, and the metal nano-particles comprises one or more selected from the group consisting of ruthenium, cobalt, nickel, iron, manganese and copper.

23. The method according to claim 22, wherein the average particle size of the solid hydrogen releasing catalyst powder is about 1 μm to 10 mm.

24. The method according to claim 13, wherein the solid hydrogen releasing catalyst powder comprises a plurality of catalyst carriers and metal ions, the metal ions chelate the surface of the catalyst carriers, and the metal ions comprise one or more selected from the group consisting of ruthenium, cobalt, nickel, iron, manganese and copper.

25. The method according to claim 24, the average particle size of the solid hydrogen releasing catalyst powder is about 1 μm to 10 mm.

26. The method according to claim 13, wherein the solid hydride powder and the solid hydrogen releasing catalyst powder are mixed well by grinding.

27. The method according to claim 13, wherein the solid hydride powder and the solid hydrogen releasing catalyst powder are mixed well after the solid hydrogen releasing catalyst powder is ground.

28. A method of using a solid hydrogen fuel which is able to be applied to a fuel cell, the method comprising:
providing a solid hydrogen fuel comprising at least a hydride powder and at least a hydrogen releasing catalyst powder which are well mixed; and
mixing the solid hydrogen fuel with water, the hydride powder and the water bring about a hydrogen releasing reaction, the hydrogen releasing catalyst powder used for catalyzing the hydrogen releasing reaction to produce hydrogen for an electrode of the fuel cell.

29. The method according to claim 28, wherein the hydride powder is sodium borohydride.

30. The method according to claim 28, wherein the solid hydrogen fuel is a pressure-formed block comprising the well-mixed hydride powder and hydrogen releasing catalyst powder.

31. The method according to claim 30, wherein the step of mixing the solid hydrogen fuel and water further comprises step of controlling the hydrogen releasing reaction by the adding amount of water.

32. The method according to claim 30, wherein a hydrogen production of the hydrogen releasing reaction reaches 90% of a theoretical value when the solid hydrogen fuel is in use.

33. The method according to claim 28 further comprising step of recycling the hydrogen releasing catalyst powder after the hydrogen releasing reaction is completed.

34. The method according to claim 33 further comprising:
recycling the hydrogen releasing powder by a screening method or magnetic collection.

35. The method according to claim 28, wherein the solid hydrogen fuel comprises a first hydride powder and a second hydride powder, and the method comprises well mixing the first and the second hydride powder and at least the hydrogen releasing catalyst powder.

36. The method according to claim 35, wherein in the step of mixing the solid hydrogen fuel and water, the first hydride powder and water bring about a first hydrogen releasing reaction, and the second hydride powder and water bring about a second hydrogen releasing reaction.

37. The method according to claim 35, wherein the percentage of the second hydride powder to the total weight of the solid hydrogen fuel is 0.001 wt % to 50 wt %.

38. The method according to claim 35, wherein the first hydride powder is sodium borohydride, and the second hydride powder is selected from the group consisting of lithium aluminum hydride, sodium aluminum hydride, magnesium aluminum hydride, calcium aluminum hydride, lithium borohydride, potassium borohydride, beryllium borohydride, magnesium borohydride, calcium borohydride, lithium hydride, sodium hydride, magnesium hydride and calcium hydride.

39. The method according claim 28, wherein the percentage of the hydrogen releasing powder to the total weight of the solid hydrogen fuel is 0.0001 wt to 50 wt %.

40. The method according claim 28, the hydrogen releasing catalyst powder is a plurality of metal nano-particles comprising of one or more selected from the group consisting of ruthenium, cobalt, nickel, iron, manganese and copper.

41. The method according to claim 28, wherein the hydrogen releasing catalyst powder comprises a plurality of catalyst carriers and metal nano-particles covering the surface of the catalyst carriers, and the metal nano-particles comprise at least one or more selected from the group consisting of ruthenium, cobalt, nickel, iron, manganese and copper.

42. The method according to claim 41, wherein the average particle size of the hydrogen releasing catalyst powder is about 1 μm to 10 mm.

43. The method according to claim 28, wherein the hydrogen releasing catalyst powder comprises a plurality of catalyst carriers and metal ions chelating the surface of the catalyst carriers, and the metal ions comprise at least one or more selected form the group consisting of ruthenium, cobalt, nickel, iron, manganese and copper.

44. The method according to claim 43, wherein the average particle size of the hydrogen releasing catalyst powder is about 1 μm to 10 mm.
